(19) United States
(12) Patent Application Publication
(10) Pub. No.: US 2026/0051599 A1
(43) Pub. Date: Feb. 19, 2026

(54) CARRIER FOR TRANSPORTING SECONDARY BATTERY

(71) Applicant: SAMSUNG SDI CO., LTD., Yongin-si (KR)

(72) Inventors: Daeseong JEONG, Yongin-si (KR); Myunghwan SEO, Yongin-si (KR); Jushik UHM, Yongin-si (KR)

(21) Appl. No.: 19/234,585

(22) Filed: Jun. 11, 2025

(30) Foreign Application Priority Data
Aug. 13, 2024 (KR) 10-2024-0108377

(51) Int. Cl. H01M 50/256; H01M 50/202; H01M 50/213; H01M 50/227; H01M 50/291

(52) U.S. Cl. CPC H01M 50/256; H01M 50/202; H01M 50/213; H01M 50/227; H01M 50/291

(57) ABSTRACT

A secondary battery transfer carrier for accommodating a secondary battery includes an accommodating part with an accommodating space, at least a portion of the secondary battery is to be accommodated in the accommodating space, and a support part integral with a lower side of the accommodating part and having a through hole, the through hole of the support part being in fluid communication with the accommodating space of the accommodating part, and the support part including a horizontal plane in an inner side of an inner surface of the accommodating part, and a first inclined surface in an inner side of the horizontal plane and having a slope of which a height is reduced toward an inner direction.

### CROSS-REFERENCE TO RELATED APPLICATION

This application claims priority under 35 U.S.C § 119 to Korean Patent Application No. 10-2024-0108377, filed in the Korean Intellectual Property Office on Aug. 13, 2024, the entire contents of which are hereby incorporated by reference.

### BACKGROUND

### 1. Field

Aspects of embodiments of the present disclosure relate to a carrier for transferring a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly. Secondary batteries may exhibit performance as batteries only if the secondary batteries go through the process of charging and discharging after manufacturing, that is, a formation process. A charger/discharger performs the function of providing characteristics of a secondary battery by repeating the charging and discharging process several times so that the first secondary battery assembled during the secondary battery production process may store electric energy. The charger/discharger may include a fixture with a probe pin for applying current required for charging and discharging to a secondary battery, and a tray on which the secondary battery is set.

The above information disclosed in this Background section is for enhancement of understanding of the background of the present disclosure, and therefore, it may contain information that does not constitute related (or prior) art.

### SUMMARY

A secondary battery transfer carrier for accommodating a secondary battery according to an embodiment of the present disclosure may include an accommodating part in which an accommodating space for accommodating at least a portion of the secondary battery is formed; and a support part in which a through hole communicating with the accommodating space is formed, and is integrally formed with the accommodating part in a lower side of the accommodating part, wherein the support part may include a horizontal plane disposed in an inner side of an inner surface of the accommodating part and a first inclined surface disposed in an inner side of the horizontal plane and having a slope of which a height is reduced toward an inner direction.

According to an embodiment, material for the accommodating part and the support part may include polyetheretherketone (PEEK).

According to an embodiment, the accommodating space and the through hole may have a cylindrical shape and a diameter of the accommodating space may be larger than that of the through hole.

According to an embodiment, an average roughness (Ra) of the horizontal plane may be 1.6 μm or less.

According to an embodiment, a maximum peak-to-valley height (Rmax) of the horizontal plane may be 6.3 μm or less.

According to an embodiment, the horizontal plane may be a plane having a certain height.

According to an embodiment, the first inclined surface may have a slope of 10° to 20° with respect to the horizontal plane.

According to an embodiment, a distance between a first edge in which the horizontal plane and the first inclined surface meet and a center of the through hole may be 20 mm or more.

According to an embodiment, a first edge in which the horizontal plane and the first inclined surface meet may be disposed in outer side more than a highest point of a top surface of the secondary battery.

According to an embodiment, a first edge in which the horizontal plane and the first inclined surface meet may be a round-processed edge.

According to an embodiment, a curvature radius of the first edge may be 5 mm to 20 mm.

According to an embodiment, the accommodating part may include a second inclined surface disposed between a top surface of the accommodating part and the inner surface of the accommodating part and having a slope of which a height is reduced toward the inner direction.

According to an embodiment, a height of the support part may be predetermined to correspond to a height of the secondary battery.

According to an embodiment, the secondary battery may be a cylindrical secondary battery.

According to an embodiment, a diameter of the secondary battery may be 40 mm to 50 mm.

According to an embodiment, a groove may be formed in an outer surface of the accommodating part along a circumference of the outer surface of the accommodating part.

A secondary battery transfer carrier for accommodating a secondary battery according to an embodiment of the present disclosure may include an accommodating part including a top surface and a first inner surface, an accommodating space for accommodating at least a portion of the secondary battery being formed inside of the first inner surface, a support part including a horizontal plane, an inclined surface, and a second inner surface, and integrally formed with the accommodating part in a lower side of the accommodating part, a through hole communicating with the accommodating space being formed inside of the second inner surface, wherein the horizontal plane may be disposed in the inner side of the first inner surface of the accommodating part, and the inclined surface disposed in an inner side of the horizontal plane and having a slope of which a height is reduced toward an inner direction.

According to an embodiment, a material for the accommodating part and the support part may include polyetheretherketone (PEEK).

According to an embodiment, an average roughness (Ra) of the horizontal plane may be 1.6 μm or less, and a maximum peak-to-valley height (Rmax) of the horizontal plane may be 6.3 μm or less.

According to an embodiment, an edge in which the horizontal plane and the first inclined surface meet may be a round-processed edge, and a curvature radius of the round-processed edge may be 5 mm to 20 mm.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a diagram illustrating a secondary battery and a secondary battery transfer carrier according to some embodiments of the present disclosure.

FIG. 2 is a diagram illustrating a cylindrical secondary battery according to some embodiments of the present disclosure.

FIG. 3 is a cross-sectional view illustrating a cylindrical secondary battery according to some embodiments of the present disclosure.

FIG. 4 is a cross-sectional view illustrating a secondary battery transfer carrier according to some embodiments of the present disclosure.

FIG. 5 is an enlarged diagram illustrating a secondary battery transfer carrier according to some embodiments of the present disclosure.

FIG. 6 is an enlarged diagram illustrating a secondary battery transfer carrier according to some embodiments of the present disclosure.

FIG. 7 is a top view illustrating a secondary battery transfer carrier when viewed in a top side according to some embodiments of the present disclosure.

FIG. 8 illustrates examples of a secondary battery transfer carrier predetermined to correspond to heights of secondary batteries according to some embodiments of the present disclosure.

FIG. 9 is a diagram explaining carrying out of a secondary battery transfer carrier according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

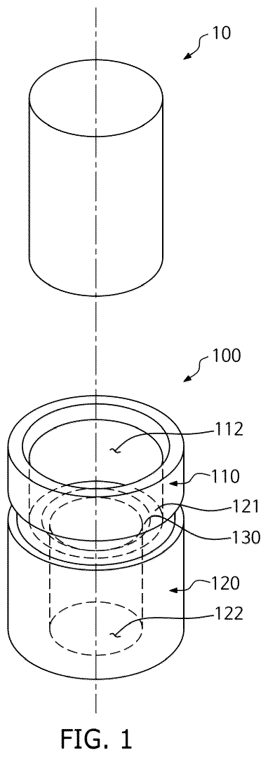

FIG. 1 is a diagram illustrating a secondary battery and a secondary battery transfer carrier according to some embodiments of the present disclosure. Referring to FIG. 1, a secondary battery 10 may be accommodated in a secondary battery transfer carrier 100.

The secondary battery 10 may be (re) chargeable and dischargeable. The secondary battery 10 may be configured of a secondary battery case, and an electrode assembly and an electrolyte accommodated in the secondary battery case. For example, in the secondary battery, the electrode assembly, in which a separator is interposed between the positive electrode and a negative electrode, may be stacked or wounded, and then accommodated in the secondary battery case together with the electrolyte in a sealed state. The electrode assembly and the electrolyte accommodated in the secondary battery case may electrochemically react to generate energy.

In some embodiments, the secondary battery 10 accommodated in the secondary battery transfer carrier 100 may be a cylindrical secondary battery. A diameter of the secondary battery 10 may be 40 mm to 50 mm.

In some embodiments, the secondary battery transfer carrier 100 may include an accommodating part 110 (e.g., an accommodator) with an accommodating space 112, in which at least a first portion of the secondary battery 10 is accommodated, and a support part 120 (e.g., a supporter) with a through hole 122 formed at a bottom side of the accommodating part 110. The accommodating part 110 and the support part 120 may be formed integrally (e.g., may be formed of a same material and in a same process to define a monolithic and seamless structure). The accommodating part 110 and the support part 120 may refer to an upper housing and a lower housing, respectively.

Referring to FIG. 1, in the secondary battery transfer carrier 100 formed in the cylindrical shape, the accommodating part 110 may refer to a portion of the secondary battery transfer carrier 100 which includes the accommodating space 112, and the support part 120 may refer to a portion of the secondary battery transfer carrier 100 which includes the through hole 122. For example, the secondary battery transfer carrier 100 may have a structure that the accommodating part 110 and the support part 120 are integral with each other. In this example, the overall shape of the secondary battery transfer carrier 100 may be a cylindrical shape.

In some embodiments, the accommodating part 110 and the support part 120 may be divided on the basis of a bottom surface of the accommodating space 112, e.g., a horizontal plane 121. For example, a part of the secondary battery transfer carrier 100 which is above the bottom surface of the accommodating space 112 in a vertical direction may be referred to as the accommodating part 110, and a part of the secondary battery transfer carrier 100 which is below the bottom surface of the accommodating space 112 in the vertical direction may be referred to as the support part 120.

In some embodiments, a material for the accommodating part 110 and the support part 120 may include polyetheretherketone (PEEK). The PEEK material may be a thermoplastic resin and may maintain the physical property even in high temperature and humid environments, and thus, the PEEK material may be effectively used as a material for the secondary battery transfer carrier 100.

In some embodiments, the accommodating space 112, in which at least a portion of the secondary battery 10 is accommodated, may be formed in the accommodating part 110. For example, the accommodating space 112 may be an empty space in the interior of the accommodating part 110, e.g., the accommodating part 110 may have an annular cross-section in a top view. The secondary battery 10 may be accommodated in the accommodating part 110 through the accommodating space 112. For example, the accommodating space 112 may be formed in a cylindrical shape. Accordingly, the accommodating space 112 may have a structure suitable for accommodating the cylindrical secondary battery.

In some embodiments, the support part 120 may be a part which is integrally formed with the accommodating part 110 on the bottom side of the accommodating part 110. The support part 120 may include the through hole 122 communicating (e.g., in fluid communication) with the accommodating space 112. For example, the through hole 122 may be formed in a cylindrical shape and communicating with the accommodating space 112. The through hole 122 may be disposed in the bottom side of the accommodating space 112 to communicate with the accommodating space 112. The through hole 122 may be formed to prevent a protrusion portion of the secondary battery 10 from being damaged when the secondary battery 10 is accommodated in the accommodating part 110. For example, when the secondary battery 10 is accommodated in the accommodating part 110, an electrode terminal of the secondary battery 10 may protrude from the accommodating part 110. In the present disclosure, the through hole 122 may be formed in the support part 120 to prevent the electrode terminal of the secondary battery 10 from being damaged.

In some embodiments, a diameter of the accommodating space 112 may be larger than that of the through hole 122. In the secondary battery transfer carrier 100, the through hole 122 may be formed to have a smaller diameter than the accommodating space 112, and thus, the horizontal plane 121 may be formed (e.g., defined) in the accommodating part 110 by a diameter difference between the accommodating space 112 and the through hole 122. A center axis of the accommodating space 112 may be the same as a center axis of the through hole 122, e.g., the through hole 122 may be concentric with the accommodating space 112.

In some embodiments, the support part 120 may include the horizontal plane 121 disposed in an inner side of an inner surface of the accommodating part 110. The horizontal plane 121 may be a plane having a certain height, e.g., the horizontal plane 121 may be a topmost surface of the support part 120 extending from an inner surface of the accommodating part 110 in parallel to a bottom of the support part 120 and the facing the interior of the accommodating part 110.

In some embodiments, the support part 120 may include a first inclined surface 130 which is disposed in the inner side of the horizontal plane 121 and has a slope with a height that is reduced toward the inner direction of the support part 120. For example, the first inclined surface 130 may extend from an edge of the horizontal plane 121 toward a center of the support part 120 in a downward direction (e.g., in a direction oriented toward the bottom of the support part 120). For example, the first inclined surface 130 may be a plane which is formed by chamfering an edge between an inner surface of the support part 120 and the horizontal plane 121. The first inclined surface 130 may be formed in the support part 120, and thus, the friction between the portion protruding from the top surface of the secondary battery 10 and the secondary battery transfer carrier 100 may be prevented when the secondary battery 10 is accommodated in the accommodating part 110. Accordingly, scratches in the top surface of the secondary battery 10 due to the friction with the secondary battery transfer carrier 100 may be prevented.

In some embodiments, an average roughness Ra of the horizontal plane 121 may be 1.6 μm or less. For example, the average roughness may also be called a center line average roughness, and may mean a value obtained by averaging heights and depths of peaks and valleys within a length, which is a certain reference of a roughness cross-sectional curve, on the basis of a reference line (e.g., q center line). For such a surface roughness, the parameter definition and measuring method defined in KS B 0601 or ISO 4287/1 may be referred to. The average roughness of the horizontal plane 121 may be formed to be 0.6 μm or less, and thus cracks or scratches which may be caused by the friction between the horizontal plane 121 and the top surface of the secondary battery 10 may be improved. Additionally or alternatively, an average roughness of the first inclined surface 130 may be 1.6 μm or less. Similarly, the average roughness of the first inclined surface 130 is formed to be 1.6 μm or less, and thus, the cracks or scratches which may be caused by the friction between the first inclined surface 130 and the top surface of the secondary battery 10 may be improved. The horizontal plane 121 and the first inclined surface 130 may be manufactured by being processed at 2,500 rpm or more using a carbide tip so as to satisfy the average roughness standard.

In some embodiments, a peak to peak height Rmax of the horizontal plane 121 may be 6.3 μm or less. For example, the peak to peak height may mean a vertical length between the highest peak and the lowest peak within the reference length of the roughness cross-sectional curve. For such a surface roughness, the parameter definition and measuring method defined in KS B 0601 or ISO 4287/1 may be referred to. The peak to peak height of the horizontal plane 121 may be formed to be 6.3 μm or less, and thus the cracks or scratches which may be caused by the friction between the horizontal plane 121 and the top surface of the secondary battery 10 may be improved. Additionally or alternatively, a peak to peak height of the first inclined surface 130 may be 6.3 μm or less. Similarly, the peak to peak height of the first inclined surface 130 is formed to be 6.3 μm or less, and thus the cracks or scratches which may be caused by the friction between the first inclined surface 130 and the top surface of the secondary battery 10 may be improved. The horizontal plane 121 and the first inclined surface 130 may be manufactured by being processed at 2,500 rpm or more using a carbide tip so as to satisfy the peak to peak height standard.

In the secondary battery transfer carrier 100 according to some embodiments of the present disclosure, the horizontal plane 121 configured to support at least a portion of the top surface of the secondary battery 10 and the first inclined surface 130 having a slope with a height that is reduced toward the inner direction may be formed in the support part 120 to prevent the protruding portion of the top surface of the secondary battery 10 from being damaged due to the friction with the secondary battery transfer carrier 100. Simultaneously, the secondary battery transfer carrier 100 may stably support the secondary battery 10 through the horizontal plane 121 which is a plane having a certain height or the first inclined surface 130.

In the secondary battery transfer carrier 100 according to some embodiments of the present disclosure, the average roughness Ra of the horizontal plane 121 may be formed to be 1.6 μm or less and the peak to peak height Rmax of the horizontal plane 121 may be formed to be formed 6.3 μm or less. Thus, the cracks or scratches which may occur due to the friction between the horizontal plane 121 and the top surface of the secondary battery 10 may be improved.

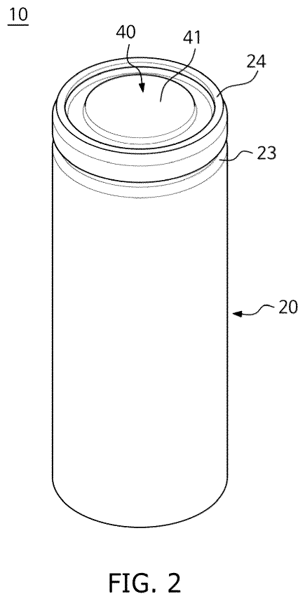

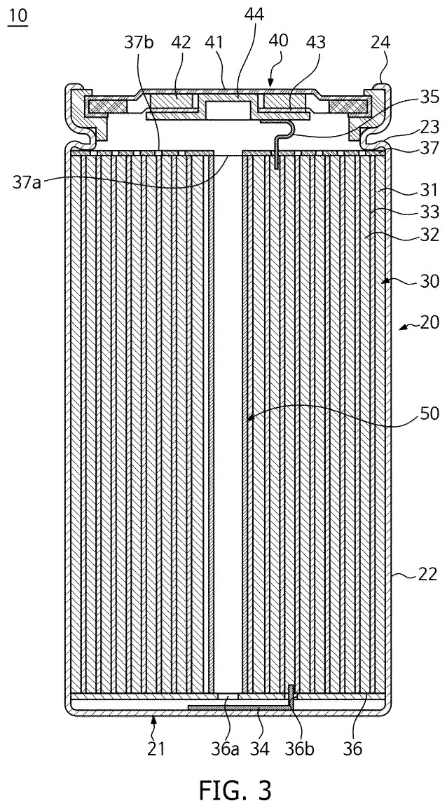

FIG. 2 is a diagram illustrating a cylindrical secondary battery according to some embodiments of the present disclosure. FIG. 3 is a cross-sectional view illustrating a cylindrical secondary battery according to some embodiments of the present disclosure.

As shown in FIGS. 2 and 3, a cylindrical lithium-ion secondary battery 10 according to one or more embodiments of the present disclosure may include a cylindrical can 20 and an electrode assembly 30. In addition, in the secondary battery 10 according to one or more embodiments of the present disclosure, the cap assembly 40 may also perform a current interruption operation and, thus, may sometimes be referred to as a current interrupt device (CID).

The cylindrical can 20 may have a substantially circular bottom part 21 and a cylindrical sidewall 22 upwardly extending (e.g., extending a predetermined length) from a circumference (or a periphery) of the bottom part 21. During the manufacturing process of the secondary battery, the top portion of the cylindrical can 20 is open. Therefore, during the assembly process of the secondary battery, the electrode assembly 30 and a center pin 50 may be inserted into the cylindrical can 20 together with an electrolyte. The cylindrical can 20 may be made of, for example, steel, stainless steel, aluminum, aluminum alloy, or an equivalent thereof but is not limited to.

In addition, to prevent the cap assembly 40 from escaping to the outside (e.g., being separated from the cylindrical can 20), with respect to the cap assembly 40, the cylindrical can 20 may include a beading part 23 (e.g., a bead) recessed toward the inside at the bottom of the cap assembly 40 and a crimping part 24 (e.g., a crimp) bent inwardly at the top thereof.

The electrode assembly 30 may be accommodated inside the cylindrical can 20. The electrode assembly 30 may include a negative electrode plate 31 coated with a negative electrode active material (e.g., graphite, carbon, etc.) on a negative electrode current collector plate, a positive electrode plate 32 coated with a positive electrode active material (e.g., a transition metal oxide, such as LiCoO₂, LiNiO₂, LiMn₂O₄, etc.) on a positive electrode current collector plate, and a separator 33 positioned between the negative electrode plate 31 and the positive electrode plate 32 to prevent a short circuit therebetween while allowing the movement of lithium ions therethrough. In addition, the negative electrode plate 31, the positive electrode plate 32, and the separator 33 may be wound in a substantially cylindrical shape. In one embodiment, the negative electrode current collector may be made of copper (Cu) foil, the positive electrode current collector may be made of aluminum (Al) foil, and the separator may be made of polyethylene (PE) or polypropylene (PP), but the present disclosure is not limited thereto.

In addition, a negative electrode tab 34 protruding and extending a certain length (e.g., a suitable length) downwardly from the electrode assembly 30 may be welded to the negative electrode plate 31, and a positive electrode tab 35 protruding and extending a certain length (e.g., a suitable length) upwardly from the electrode assembly 30 may be welded to the positive electrode plate 32, but an opposite configuration is possible. In addition, for example, the negative electrode tab 34 may be made of copper (Cu) or nickel (Ni), and the positive electrode tab 35 may be made of aluminum (Al), but the present disclosure is not limited thereto.

In addition, the negative electrode tab 34 of the electrode assembly 30 may be welded to the bottom part 21 of the cylindrical can 20. Therefore, the cylindrical can 20 may act as a negative electrode. Of course, alternatively, the positive electrode tab 35 may be welded to the bottom part 21 of the cylindrical can 20, and in such an embodiment, the cylindrical can 20 may act as a positive electrode.

In addition, the secondary battery 10 may include a first insulation plate 36 coupled to the cylindrical can 20, may have a first hole 36a in the center and one or more second holes 36b outside (e.g., peripheral to the center) thereof, and may be interposed between the electrode assembly 30 and the bottom part 21. The first insulation plate 36 prevents the electrode assembly 30 from electrically contacting the bottom part 21 of the cylindrical can 20. By way of example, the first insulation plate 36 prevents the positive electrode plate 32 of the electrode assembly 30 from electrically contacting the bottom part 21. The first hole 36a allows the gas to quickly move upwardly through the center pin 50 if (or when) a large amount of gas is generated due to an abnormality of the secondary battery 10, and the one or more second holes 36b allow the negative electrode tab 34 to penetrate (or extend) therethrough and be welded to the bottom part 21.

In addition, the secondary battery 10 may include a second insulation plate 37 coupled to the cylindrical can 20, having a first hole 37a in the center and a plurality of second holes 37b formed outside thereof (e.g. located peripherally to the center), and may be interposed between the electrode assembly 30 and the cap assembly 40. The second insulation plate 37 prevents the electrode assembly 30 from electrically contacting the cap assembly 40. By way of example, the second insulation plate 37 prevents the negative electrode plate 31 of the electrode assembly 30 from electrically contacting the cap assembly 40. The first hole 37a allows the gas to quickly move toward the cap assembly 40 if (or when) a large amount of gas is generated due to an abnormality of the secondary battery, and the second holes 37b allow the positive electrode tab 35 to penetrate (or extend) therethrough and be welded to the cap assembly 40. In addition, the remaining second holes 37b allow an electrolyte to quickly flow into the electrode assembly 30 in an electrolyte injection process.

In addition, the diameters of the first holes 36a and 37a of the first and second insulation plates 36 and 37 are formed to be smaller than the diameter of the center pin 50, thereby preventing the center pin 50 from electrically contacting the bottom part 21 of the cylindrical can 20 or the cap assembly 40 due to an external impact.

The center pin 50 has a shape of a hollow circular pipe and may be coupled to the center of the electrode assembly 30. The center pin 50 may be made of, for example, steel, stainless steel, aluminum, an aluminum alloy, or polybutylene terephthalate, but the present disclosure is not limited thereto. The center pin 50 suppresses (or prevents) deformation of the electrode assembly 30 during charging and discharging of the battery and acts as a passage for gas generated inside the secondary battery. Of course, in some embodiments, the center pin 50 may be omitted.

The cap assembly 40 may include a top plate 41, a middle plate 42, an insulation plate 43, and a bottom plate 44.

The middle plate 42 is located below the top plate 41 and may have a substantially flat shape.

When viewed from the bottom, the insulation plate 43 may be formed in a circular ring shape having a suitable width (e.g., a predetermined width). In addition, the insulation plate 43 insulates the middle plate 42 and the bottom plate 44 from each other. The insulation plate 43 may be interposed between, for example, the middle plate 42 and the bottom plate 44 to then be ultrasonically welded, but the present disclosure is not limited thereto.

In some aspects, the top surface of the secondary battery 10 may refer to a surface corresponding to the cap assembly 40 of the secondary battery 10. For example, the top surface of the secondary battery 10 may refer to an upper part of the secondary battery 10 as shown in FIGS. 2 and 3. In some embodiments, the highest point of the top surface of the secondary battery 10 may be a portion of the crimping part 24.

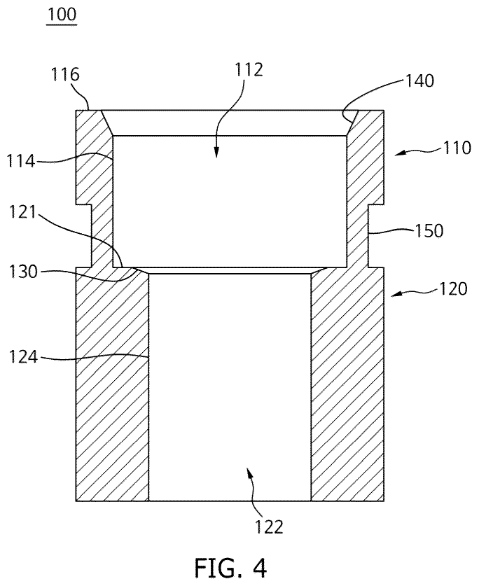

FIG. 4 is a cross-sectional view illustrating the secondary battery transfer carrier 100 according to some embodiments of the present disclosure.

As shown in FIG. 4, the secondary battery transfer carrier 100 may include the accommodating part 110, in which the accommodating space 112 configured to accommodate the secondary battery 10 is formed in an inside thereof, and the support part 120, in which the through hole 122 communicating with the accommodating space 112 is formed in an inside thereof. The support part 120 may be formed integrally with the accommodating part 110 in the bottom side of the accommodating part 110. For example, the overall shape of the secondary battery transfer carrier 100 may be a cylindrical shape.

In some embodiments, the accommodating space 112 and the through hole 122 may have a cylindrical shape, and the diameter of the accommodating space 112 may be larger than that of the through hole 122. Accordingly, the horizontal plane 121 configured to support the top surface of the secondary battery 10 may be formed in the accommodating part 110 due to the diameter difference between the accommodating space 112 and the through hole 122.

In some embodiments, the support part 120 may include the horizontal plane 121 configured to support at least a portion of the top surface of the secondary battery 10, and the first inclined surface 130 disposed in the inner side of the horizontal plane 121 and having the height reduced toward the inner direction.

In some embodiments, the accommodating part 110 may include a second inclined surface 140 which is disposed between an inner surface 114 and a top surface 116 of the accommodating part 110. The second inclined surface 140 may have a slope of which a height is reduced toward the inner direction. For example, the inner direction may be a direction from an outer side of the secondary battery transfer carrier 100 toward a central portion thereof. The second inclined surface 140 may be a surface formed by chamfering an edge between the inner surface 114 and the top surface 116 of the accommodating part 110. The second inclined surface 140 may be formed in a top side of the accommodating part 110, and thus the scratches due to the friction between the top surface of the secondary battery 10 and the inner surface 114 of the accommodating part 110, which may occur in the top surface of the secondary battery 10 in a process of accommodating the secondary battery 10 into the secondary battery transfer carrier 100, may be reduced.

In some embodiments, a groove 150 having a certain depth may be formed in an outer surface of the accommodating part 110 along a circumference of the accommodating part 110. For example, the groove 150 formed in the outer surface of the accommodating part 110 may serve as a guide so that the secondary battery transfer carrier 100 may be smoothly fixed to a griper or tray for transporting a carrier and the like when the secondary battery transfer carrier 100 is transported or loaded within a process.

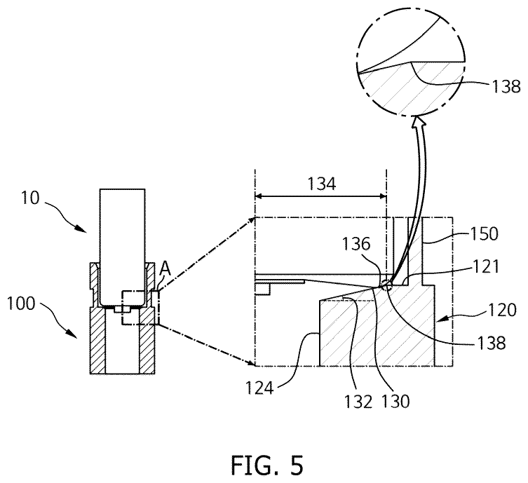

FIG. 5 is an enlarged diagram illustrating the secondary battery transfer carrier 100 according to some embodiments of the present disclosure. As shown in FIG. 5, the secondary battery 10 may be accommodated in the secondary battery transfer carrier 100, and the horizontal plane 121 or the first inclined surface 130 of the secondary battery transfer carrier 100 may support at least a portion of the top surface of the secondary battery 10.

In some embodiments, the support part 120 may include the first inclined surface 130 which is disposed in the inner side of the horizontal plane 121 and has the slope of which the height is reduced toward the inner direction of the support part 120. For example, the first inclined surface 130 may be a surface which is formed by chamfering the edge between the inner surface of the support part 120 and a top surface of the support part 120.

In some embodiments, the first inclined surface 130 may have a slope of 10° to 20° with respect to the horizontal plane 121. For example, in the first inclined surface 130, an angle 132 formed by a line parallel with the horizontal plane 121 and the first inclined surface 130 may be 10° to 20°. When the angle 132 between the line parallel with the horizontal plane 121 and the first inclined surface 130 is less than 10°, scratches may occur in the top surface of the secondary battery 10 due to friction with the first inclined surface 130. When the angle 132 between the line parallel with the horizontal plane 121 and the first inclined surface 130 is greater than 20°, an edge 138 in which the first inclined surface 130 and the horizontal plane 121 meet may be sharply formed, and thus, scratches may occur in the top surface of the secondary battery 10. Accordingly, the angle 132 between the line parallel with the horizontal plane 121 and the first inclined surface 130 may be formed to be 10° to 20°, and thus, scratches which may occur in the top surface of the secondary battery 10 may be minimized.

In some embodiments, the edge 138 in which the first inclined surface 130 and the horizontal plane 121 meet may be positioned in an outer side more than (e.g., farther from a central axis of the support part 120 than) a highest point or a highest point 136 of the top surface of the secondary battery 10. The top surface of the secondary battery 10 may have a structure that a center is dent and the outer side protrudes through the production process of the secondary battery 10. The first inclined surface 130 may be formed so that the edge 138 in which the first inclined surface 130 and the horizontal plane 121 meet may be positioned in the outer side more than the highest point 136 of the top surface of the secondary battery 10, and thus, the highest point 136 of the top surface of the secondary battery 10 may be supported by the first inclined surface 130. Through such a configuration, the weight of the secondary battery 10 applied to the highest point 136 of the top surface of the secondary battery 10 may be dispersed, and the scratches which may occur in the top surface of the secondary battery 10 may be minimized.

In some embodiments, a distance 134 between the edge 138 in which the first inclined surface 130 and the horizontal plane 121 meet and the center of the through hole may be 20 mm or more.

The secondary battery transfer carrier 100 according to some embodiments of the present disclosure may improve (e.g., minimize) the scratches, which may occur in the top surface of the secondary battery 10, through the configuration which forms the first inclined surface 130 in the inner side of the horizontal plane 121. The angle 132 formed by the line parallel with the horizontal plane 121 and the first inclined surface 130 may be formed to be 10° to 20°, and thus, scratches which may occur in the top surface of the secondary battery 10 may be minimized. The edge 138 in which the first inclined surface 130 and the horizontal plane 121 meet is positioned in the outer side more than the highest point 136 of the top surface of the secondary battery 10, and thus, the weight of the secondary battery 10 applied to the highest point 136 of the top surface of the secondary battery 10 may be dispersed, and scratches which may occur in the top surface of the secondary battery 10 may be minimized.

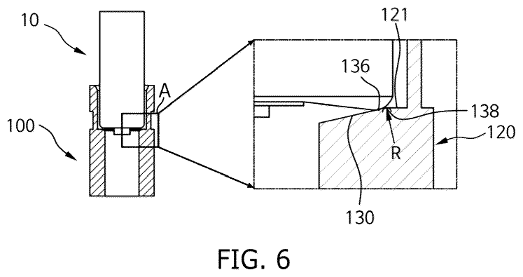

FIG. 6 is an enlarged diagram illustrating a secondary battery transfer carrier according to some embodiments of the present disclosure.

Referring to FIG. 6, in some embodiments, the edge 138 in which the first inclined surface 130 and the horizontal plane 121 meet may be processed to be rounded. When the edge 138 in which the first inclined surface 130 and the horizontal plane 121 meet is in contact with the top surface of the secondary battery 10, scratches may occur in the top surface of the secondary battery 10 by a sharp portion of the edge 138. Accordingly, the edge 138 in which the first inclined surface 130 and the horizontal plane 121 meet may be processed to be rounded, and thus, scratches which may occur in the top surface of the secondary battery 10 may be minimized. In some embodiments, a curvature radius R of the edge 138 in which the first inclined surface 130 and the horizontal plane 121 meet may be 5 mm to 20 mm.

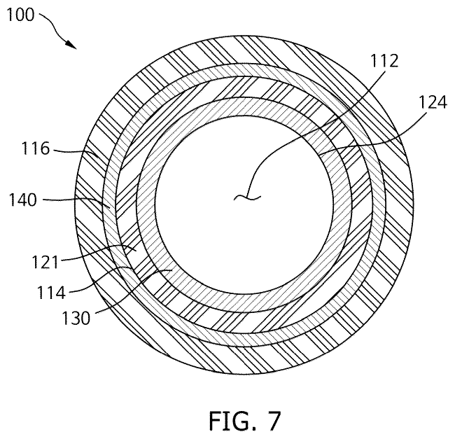

FIG. 7 is a top view illustrating the secondary battery transfer carrier 100 when viewed in a top side according to some embodiments of the present disclosure. FIG. 7 illustrates the secondary battery transfer carrier of FIG. 4 when viewed in a top view.

As shown in FIG. 7, when viewing the secondary battery transfer carrier 100 in a top side, the top surface 116 of the accommodating part 110 may be formed in the outermost side of the secondary battery transfer carrier 100. The second inclined surface 140 may be formed in the inner side of the top surface 116 of the accommodating part 110. For example, the second inclined surface 140 may be a surface formed by chamfering the edge between the inner surface 114 and the top surface 116 of the accommodating part. The second inclined surface 140 may have a slope of which a height is reduced toward the inner direction. Then, the horizontal plane 121 may be formed in the inner side of the second inclined surface 140. The horizontal plane 121 may be a plane which supports at least a portion of the top surface of the secondary battery 10 and has a certain height. Then, the first inclined surface 130 which has a slope of which a height is reduced toward the inner direction may be formed in the inner side of the horizontal plane 121. The first inclined surface 130 may be a surface formed by chamfering the edge between an inner surface 124 and the horizontal plane 121 of the support part. Next, the accommodating space 112 in which the at least a portion of the secondary battery is accommodated may be formed in the inner side of the first inclined surface 130.

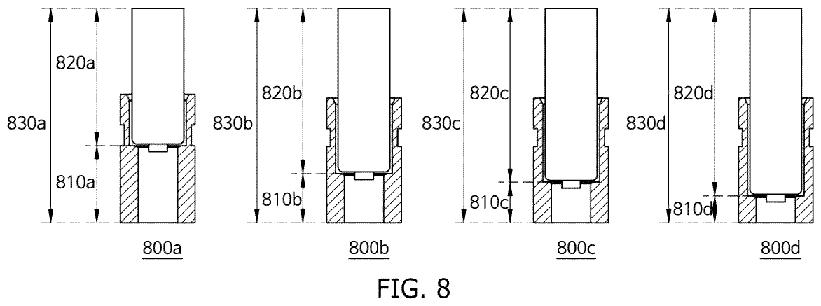

FIG. 8 illustrates examples of secondary battery transfer carriers corresponding to heights of secondary batteries according to some embodiments of the present disclosure. As shown in FIG. 8, in the secondary battery transfer carrier according to some embodiments, a height of the support part may be predetermined to correspond to the height of the secondary battery.

As shown in a first to a fourth examples 800a, 800b, 800c, and 800d, sums 830a, 830b, 830c, and 830d of heights 810a, 810b, 810c, and 810d of the support parts and heights 820a, 820b, 820c, and 820d of the second batteries may have the same value in the first example 800a to the fourth example 800d. For example, the sum of the height of the support part and the height of the secondary battery may be predetermined, e.g., constant, as 125 mm. In the first example 800a, when the height 820a of the first secondary battery is 80 mm, the height 810a of the first support part may be determined as 45 mm. The height 810a of the first support part may be a value which subtracts 80 mm from 125 mm. In the second example 800b, when the height 820b of the second secondary battery is 95 mm, the height 810b of the second support part may be determined as 30 mm. In the third example 800c, when the height 820c of the third secondary battery is 100 mm, the height 810c of the third support part may be 25 mm. In the fourth example 800d, when the height 820d of the fourth secondary battery is 120 mm, the height 810d of the fourth support part may be determined as 5 mm.

In the secondary battery transfer carrier according to some embodiments, the height of the support part may be predetermined to correspond to the height of the secondary battery, and thus, the secondary battery transfer carrier, which may be used to transfer the secondary batteries having different heights from each other, may be provided without change in a process condition.

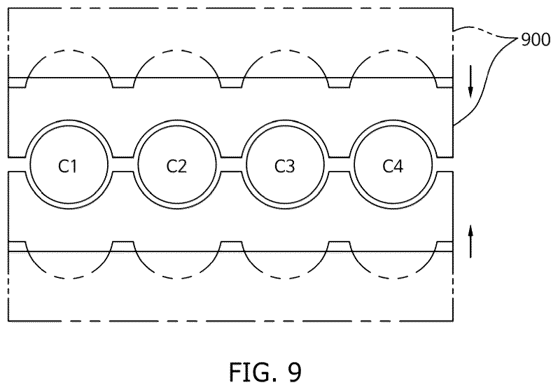

FIG. 9 is a diagram explaining carrying out of a secondary battery transfer carrier according to some embodiments of the present disclosure.

Referring to FIG. 9, guides 900 may be disposed with secondary battery transfer carriers C1 to C4 interposed therebetween in a state that the guides are spaced to face each other (see virtual line). Then, the guides 900 may be controlled to move toward the secondary battery transfer carriers C1 to C4 and to support the secondary battery transfer carriers C1 to C4. For example, a plurality of concave grooves may be formed in each of an upper guide and a lower guide. Accordingly, the guides 900 may support the secondary battery transfer carriers C1 to C4 through the concave grooves thereof. In this example, each of the concave grooves of the guides 900 may be manufactured in a shape corresponding to the groove formed along the circumference of the outer surface of the accommodating part in each of the second battery transfer carriers. Accordingly, the upper guide and the lower guide may be inserted into the grooves formed along the circumferences of the outer surfaces of the accommodating parts in the secondary battery transfer carriers to support the secondary battery transfer carriers C1 to C4. The secondary battery transfer carrier supported by the guides 900 may be carried out to a next or a subsequent process unit through a conveyer and the like.

For example, as illustrated in FIG. 9, the secondary battery transfer carriers may be carried out through the guides 900. In another example, the secondary battery transfer carrier may be supported through a pick and place robot and the like and carried out to a subsequent process unit.

By way of summation and review, a cylindrical secondary battery may have a larger capacity than a prismatic type secondary battery or a pouch type secondary battery in a structural aspect. However, in a production process of the cylindrical secondary battery, cracks or scratches may occur in a cylindrical case which accommodates the cylindrical secondary battery. Factors that cause the cracks or scratches may be various (e.g., during the manufacturing process, friction with a transfer apparatus in a process of transferring the secondary battery may cause the cracks or scratches). Therefore, the secondary battery in which the scratches occur during the manufacturing process may be classified as defective and discarded. Therefore, preventing the scratches from occurring in the case of the secondary battery may be a key factor for productivity improvement.

Therefore, aspects of embodiments of the present disclosure provide a carrier for transferring a secondary battery with a horizontal plane, which is disposed in an inner side of an inner surface of an accommodating part, and a first inclined surface, which has a slope of which a height is reduced toward an inner direction, in a support part to prevent a protruding portion of a top surface of the secondary battery from being damaged due to friction with the secondary battery transfer carrier. Simultaneously, the secondary battery transfer carrier may stably support the secondary battery through the horizontal plane, which is a plane having a certain height, and the first inclined surface disposed in an inner side of the horizontal plane.

In the secondary battery transfer carrier according to some embodiments of the present disclosure, an average roughness Ra of the horizontal plane is formed to be 1.6 μm or less, and a peak to peak height Rmax of the horizontal plane is formed to be 6.3 μm or less, so that cracks or scratches which may occur due to fiction between the horizontal plane and the top surface of the secondary battery may be minimized.

The secondary battery transfer carrier according to some embodiments of the present disclosure may minimize scratches which may occur in the top surface of the secondary battery through a configuration in which the first inclined surface is formed in the inner side of the horizontal plane. In other embodiments, an angle between a line in parallel with the horizontal plane and the first inclined surface may be formed to be 10° to 20°, and thus the scratches which may occur in the top surface of the secondary battery may be minimized. In further other embodiments, an edge in which the horizontal plane and the first inclined surface meet may be positioned in outer side more than the highest point (peak point) in the top surface of the secondary battery, so that the weight of the secondary battery applied to the highest point out of the top surface of the secondary battery may be dispersed and the scratches which may occur in the top surface of the secondary battery may be minimized.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery transfer carrier for accommodating a secondary battery, the transfer carrier comprising:
an accommodating part with an accommodating space, at least a portion of the secondary battery is to be accommodated in the accommodating space; and
a support part that is integral with a lower side of the accommodating part and having a through hole, the through hole of the support part being in fluid communication with the accommodating space of the accommodating part, and the support part including:
a horizontal plane in an inner side of an inner surface of the accommodating part, and
a first inclined surface in an inner side of the horizontal plane and having a slope of which a height is reduced toward an inner direction.

2. The secondary battery transfer carrier as claimed in claim 1, wherein each of the accommodating part and the support part includes polyetheretherketone.

3. The secondary battery transfer carrier as claimed in claim 1, wherein each of the accommodating space and the through hole has a cylindrical shape, a diameter of the accommodating space being larger than a diameter of the through hole.

4. The secondary battery transfer carrier as claimed in claim 1, wherein an average roughness (Rₐ) of the horizontal plane is 1.6 μm or less.

5. The secondary battery transfer carrier as claimed in claim 1, wherein a maximum peak-to-valley height (Rₘₐₓ) of the horizontal plane is 6.3 μm or less.

6. The secondary battery transfer carrier as claimed in claim 1, wherein the horizontal plane is a plane having a certain height.

7. The secondary battery transfer carrier as claimed in claim 6, wherein the first inclined surface has a slope of 10° to 20° with respect to the horizontal plane.

8. The secondary battery transfer carrier as claimed in claim 1, wherein a distance between a first edge, in which the horizontal plane and the first inclined surface meet, and a center of the through hole is 20 mm or more.

9. The secondary battery transfer carrier as claimed in claim 1, wherein a first edge, in which the horizontal plane and the first inclined surface meet, is farther than a highest point of a top surface of the secondary battery.

10. The secondary battery transfer carrier as claimed in claim 1, wherein a first edge, in which the horizontal plane and the first inclined surface meet, is rounded.

11. The secondary battery transfer carrier as claimed in claim 10, wherein a curvature radius of the first edge is 5 mm to 20 mm.

12. The secondary battery transfer carrier as claimed in claim 1, wherein the accommodating part includes a second inclined surface between a top surface of the accommodating part and the inner surface of the accommodating part, the second inclined surface having a slope of which a height is reduced toward the inner direction.

13. The secondary battery transfer carrier as claimed in claim 1, wherein a height of the support part is predetermined to correspond to a height of the secondary battery.

14. The secondary battery transfer carrier as claimed in claim 1, wherein an inner shape of the accommodating space is cylindrical, the secondary battery being a cylindrical secondary battery.

15. The secondary battery transfer carrier as claimed in claim 14, wherein a diameter of the secondary battery is 40 mm to 50 mm.

16. The secondary battery transfer carrier as claimed in claim 1, further comprising a groove in an outer surface of the accommodating part along a circumference of the outer surface of the accommodating part.

17. A secondary battery transfer carrier for accommodating a secondary battery, the transfer carrier comprising:
an accommodating part including a top surface, a first inner surface, and an accommodating space inside the first inner surface, at least a portion of the secondary battery is to be accommodated in the accommodating space; and
a support part that is integral with a lower side of the accommodating part and having a horizontal plane in the inner side of the first inner surface of the accommodating part, an inclined surface in an inner side of the horizontal plane and having a slope of which a height is reduced toward an inner direction, a second inner surface, and a through hole inside of the second inner surface, the through hole being in fluid communication with the accommodating space of the accommodating part.

18. The secondary battery transfer carrier as claimed in claim 17, wherein each of the accommodating part and the support part includes polyetheretherketone.

19. The secondary battery transfer carrier as claimed in claim 17, wherein an average roughness (Rₐ) of the horizontal plane is 1.6 μm or less, and a maximum peak-to-valley height (Rₘₐₓ) of the horizontal plane is 6.3 μm or less.

20. The secondary battery transfer carrier as claimed in claim 17, wherein an edge, in which the horizontal plane and the inclined surface meet, is rounded, a curvature radius of the edge being 5 mm to 20 mm.
